(19) United States
(12) Patent Application Publication
(10) Pub. No.: US 2018/0087715 A1
(43) Pub. Date: Mar. 29, 2018

(54) DOOR FRAME DEVICE HOLDER

(71) Applicant: Dia White, Rosharon, TX (US)

(72) Inventor: Dia White, Rosharon, TX (US)

(21) Appl. No.: 15/700,820

(22) Filed: Sep. 11, 2017

Related U.S. Application Data
(60) Provisional application No. 62/401,311, filed on Sep. 29, 2016.

(51) Int. Cl. F16M 13/02; F16M 11/04; A47B 23/02

(52) U.S. Cl. CPC F16M 13/022; F16M 2200/06; A47B 23/025; F16M 11/04

(57) ABSTRACT

A holding apparatus for an electronic device allowing hands-free use comprised of a support cradle for receiving and positioning an electronic device for use and viewing that includes a support base extending horizontally from the support cradle and a lip extending vertically upward from the support base, and a non-skid surface to aid keeping the electronic device in place. A flexible support arm attaches to the support cradle and attaches to a mounting plate. The mounting plate includes an attachment mechanism for attaching to a two-sided panel, with a first side for mounting to an object and a second side for attaching to the mounting plate. The attachment mechanism for the second side includes a male-female connection formed by a plurality of female slotted holes and a plurality of matching male protrusions.

### CROSS-REFERENCE TO RELATED APPLICATION(S)

The application claims benefit of US Provisional Application 62/401,311 filed Sep. 26, 2016 entitled “DOOR FRAME PHONE HOLDER,” incorporated herein.

### BACKGROUND OF THE INVENTION

### 1. Field of Invention

The present invention relates generally to a holding device capable of holding a portable electronic device or other item suspended from a door hinge. In particular, the present invention utilizes a two-sided panel screwed onto a door hinge to suspend a housing panel or support containing the exemplary portable electronic device therefrom.

### 2. Description of Related Art

The present invention is an apparatus that attaches to the hinges of a door and/or the door frame preferably in the bathroom, holding a portable electronic device therein. The attachment is designed so that a user can have hands free use of portable devices such as cell phones, tablets, laptops or the like. The present invention comprises a flat two-sided plate with one side of the plate that screws onto or otherwise attaches to the door hinge and with the second side of the place that connects to a mounting providing support to an attached flexible or resilient arm extending away from the door frame and terminating in an angled support cradle with tacky and/or non-skid surface.

Prior art solutions, such as that seen in US Pub 2010/0288895, use clamps and grips to attach a support arm to an object and/or secure an electronic device to a support cradle.

Developing technology has given rise to a number of devices such as tablets and smart phones optimized for streaming various types of entertainment media as well as supporting phone calls. Increasingly, such mobile devices lend themselves to easy transport, including carrying the device into a bathroom or being viewed while in bed.

Based on the foregoing, there is a need in the art a system, which enables easy attachment to a door frame of a bathroom or a bed to facilitate easy viewing and use of an electronic device.

### SUMMARY OF THE INVENTION

An electronic device holding apparatus, comprises a support cradle for receiving and positioning an electronic device for use and viewing, the support cradle including a support base extending horizontally from the support cradle and a lip extending vertically upward from the support base, and wherein the support cradle includes a non-skid surface to aid keeping the electronic device in place. A flexible support arm having a first end and a second end, with the first end attached to the support cradle and the second end attached to a mounting plate. Wherein the mounting plate includes an attachment mechanism for attaching to a two-sided panel comprising a first side for mounting to an object and a second side for attaching to the mounting plate, and wherein the attachment mechanism for the second side comprises a male-female connection formed by a plurality of female slotted holes and a plurality of matching male protrusions.

The object comprises at least one of a door and a bed.

The object comprises a hinge and the first side includes holes aligned concentrically to match screws in a hinge of a door frame.

The non-skid surface includes a tacky surface.

The support arm includes at least one interposed joint between the mounting plate and the support cradle.

The joint comprises at least one of the following: CV joint, hinged joint, prismatic joint, cylindrical joint, planar joint, ball joint, and screw joint.

The two-sided panel comprises a hinge interposed therebetween.

A holding apparatus for hands-free use of an electronic device that comprises a support cradle for receiving and positioning an electronic device for use and viewing and a support arm having a first end and a second end, the first end attached to the support cradle and the second end attached to a mounting plate, with at least one joint interposed between the support cradle and the mounting plate. The mounting plate includes an attachment mechanism for attaching to a two-sided panel comprising a first side for mounting to an object and a second side for attaching to the mounting plate.

The support arm is flexible and can be arrange into multiple shapes.

The attachment mechanism for the second side comprises a male-female connection formed by a plurality of female slotted holes and a plurality of matching male protrusions.

Advantages:

1. Improved convenience.

2. Improved communication through hands-free operation.

3. Improved efficiency with multi-task capability.

4. Improved productivity through continued use of the mobile device.

5. Reduced damage or loss as the mobile device is retained in a known position.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a side view of the invention showing the two-sided panel/mount, a flexible arm, and a support cradle, according to an embodiment of the present invention;

FIG. 2 is a is a perspective view the two-sided panel/mount, according to an embodiment of the present invention;

FIG. 3 is a side view of the two-sided panel fastened to a double jointed arm/arm and the housing panel, according to an embodiment of the present invention;

FIG. 4 shows an illustrative view of how the present invention is supposed to engage with the door hinge, according to an embodiment of the present invention; and

FIG. 5 shows an illustrative view of the present invention engaged to the door hinge leading into a toilet, according to an embodiment of the present invention.

### DETAILED DESCRIPTION OF PREFERRED EMBODIMENTS

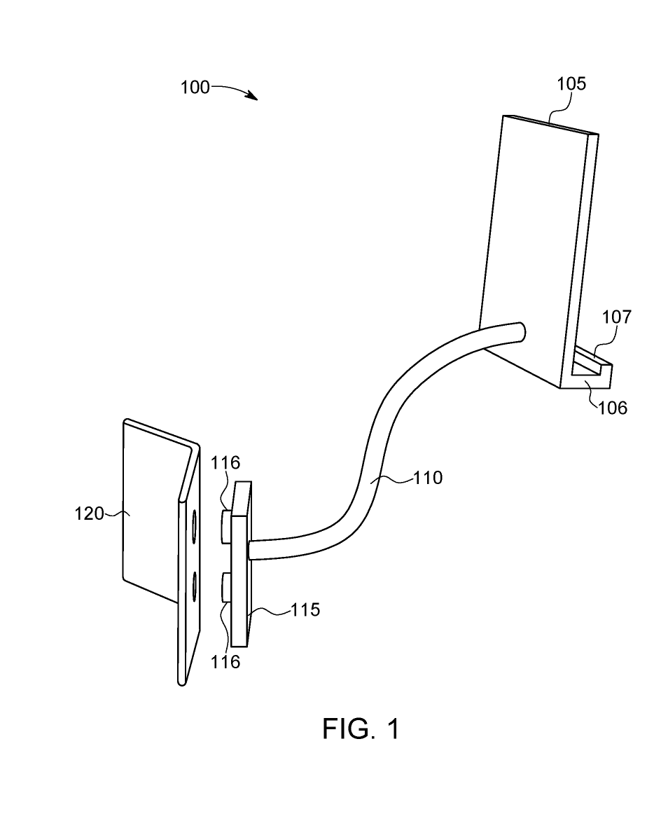

Preferred embodiments of the present invention and their advantages may be understood by referring to FIGS. 1-5, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, an electronic device holder 100 can comprise a support cradle 105 that can connect to one end of flexible arm 110. Flexible arm 110 can comprise a length of plastic or vinyl coated metal, such as a length of coated metal gooseneck tubes, conduit tubing, or the like. The flexible arm 110 can also be made from a chrome-plated or stainless steel flex tubing able to freely curve and position into numerous shapes and retain that shape during use. The support cradle 105 can further comprise a support base 106 with a raised lip 107 forming a vertical retainer. The surface of support cradle 105 can further include a non-skid surface to help retain an electronic device, such as a cell phone, personal digital assistant, smart phone, tablet, laptop, or the like, in place. Furthermore, the support cradle 105 can comprise a tacky surface to aid in retention.

The other end of flexible arm 110 can connect to a mounting plate 115 used as a mount for the flexible arm 110. The mounting plate 115 can include a set of male protrusions 116 designed for inserting into female slots on a two-sided panel 120 having an approximate 90° bend between the two sides. The two-sided panel 120 can be hinged to allow its use in a door frame mounted on top of or replacing a conventional door hinge or a solid 90° bent segment of sheet metal or high strength plastic.

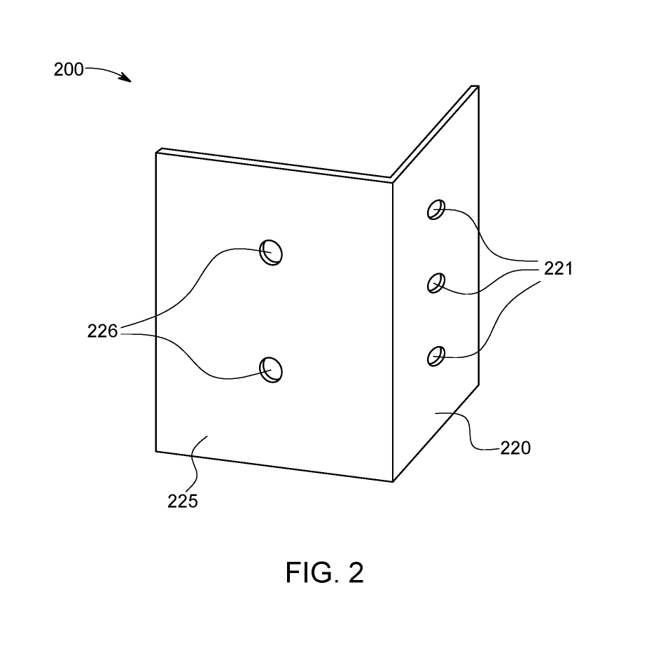

In reference to FIG. 2, as depicted in an embodiment of the present invention, a holding apparatus, two-sided panel, 200 can be used to attach mounting plate 115 of electronic device holder 100. The first side panel 220 can be lined with a plurality of holes 221 having female threads disposed therein enabling the holding apparatus 200 to attach to a door hinge found on most conventional door frames. The holes 226 can be aligned concentrically with the threaded holes disposed on conventional door frames and fastened together with screws driven through both the holding apparatus 200 and a door hinge. The second side panel 225 can comprise a set of key-holed slots 226 permitting the attachment of the flexible arm 110. The key-holed slots 226 can function as female slots to receive male protrusions 116 of mounting plate 115. In an alternate embodiment, first side panel 200 can be attached directly to a door frame.

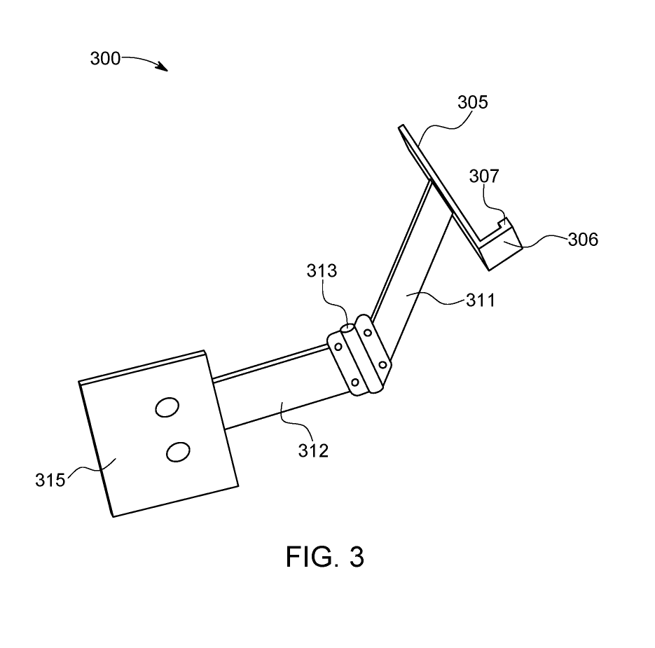

Referring to FIG. 3, an alternative embodiment of an electronic device holder 300 is depicted with an articulating support arm a first rigid arm segment 311 and a second rigid arm segment 312 thereon. The first arm segment 311 connects to second arm segment 312 via articulating joint 313. The second arm segment 213 can be attached to mounting plate 315 to selectively fasten to second side panel 225 via screws or similar detachable fastening mechanisms, such as the slotted female and male coupling scheme depicted in FIG. 2.

The first arm segment 311 can connect to support cradle 305 having a support base 306 with a lip 307 and can rotatably be engaged to the distal end of the first support arm 311. Rotatable engagement is enabled by a constant velocity (CV) joint (not shown) where first support arm 311 connects to support cradle 305 and/or joint 313 which can connect first support arm 311 to second support arm 312, which can comprise perpendicular members. The perpendicular members serve as axles allowing the first and the second arms 311 and 312 to rotate thereabout, thereby allowing the placement of the support cradle 305 anywhere on a spherical area surrounding two-sided panel 312. In order to ensure the support cradle 305 remains substantially parallel to the user, a second CV joint can connect the support cradle 305 o the distal end of the first support arm 311.

In alternate embodiments of the present invention, any mechanism allowing free placement of the support cradle 305 in a spherical area around the two-sided panel 320 may be utilized in place of the CV joints. For examples, hinged joints, prismatic joints, cylindrical joints, planar joints, ball joints, screw joints, and/or the like may be utilized in alternate embodiments. It is also easily conceivable to those with ordinary skills in the relevant arts, that prismatic joints may allow the first and second arms 311 and 312 to extend or contract thereby increasing the range at which the support cradle 305 can be suspended above the two-sided panel 320. Many variations and modifications to the depicted double jointed arm may be conceived in alternate embodiments.

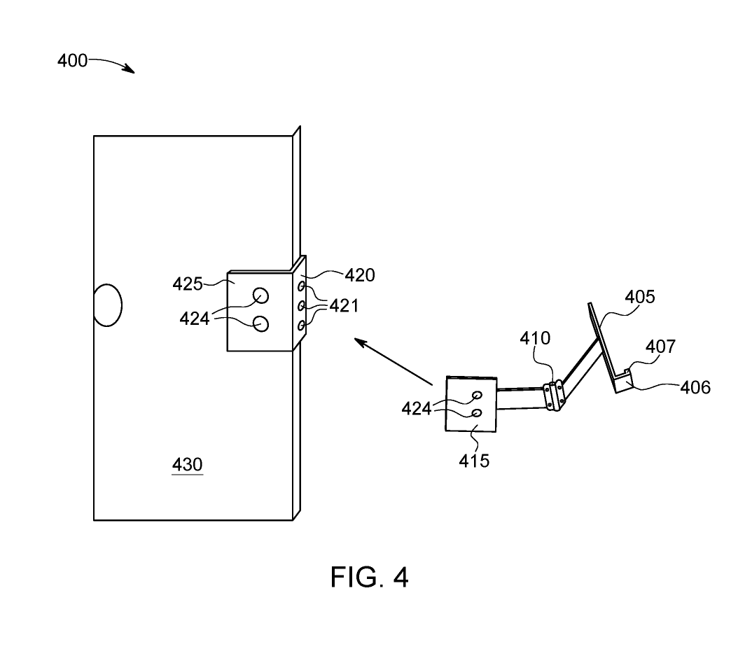

In reference to FIG. 4, the holding apparatus 400 can include a support cradle 405 formed from an L-shaped sheet of metal or similarly rigid material capable of securely holding a portable electronic device in a reclined position therein. A portable electronic device rests on top of the horizontal section, support base 406 of the support cradle 407, with a vertical section providing longitudinal support in the tilted position. Lip 407 can aid in keeping an electronic device from slipping off vertically.

Support cradles 403 having different sizes and shapes may be selectively fastened to the distal end of the support arm 410 order to secure portable electronic devices having varying sizes. In yet another aspect of the present invention, the support cradle 403 may comprise mechanisms allowing lateral or horizontal extensibility thereby varying the length and the width of the support cradle 410. This may be facilitated using a modular design comprising components slidably engaged to one another. In order to increase the overall size of the support cradle 405, modular components extend and are locked into position with a simple locking mechanism such as male snap interlocking with a female snap, in order to secure the portable electronic device stored within the support cradle 405.

In yet another aspect of the present invention, the holding apparatus 400 can include a pair of perpendicularly aligned telescoping members that may be attached to support cradle 405 and used to hold the portable electronic device. Plastic tabs disposed on the ends of the telescoping members may be used to securely grip onto the portable electronic device. The telescoping members may be expanded or retracted in order to fit portable electronic devices having varying sizes. Many variations and modifications to the preferred housing panel are easily conceivable.

In yet another aspect of the present invention, one or more suction cups 424 can be used to create a selective engagement between the mounting plate 415 apparatus and the two-sided panel 420. The suction cups 424 may comprise components and arrangements well known and widely utilized in the relevant arts. Suction cups 424 can be integrated on either mounting plate 415 or second side panel 425. In turn, the first side panel 420 may include a plurality of holes 423 to match and attach to screws of a door hinge. In this embodiment, it is possible to attach the holding apparatus 400 to any non-porous smooth surface, such as directly to door 430, which may be covered by the suction cups 424 and any gas may be evacuated therefrom. Many variations and modifications to the engaging mechanism are easily conceivable.

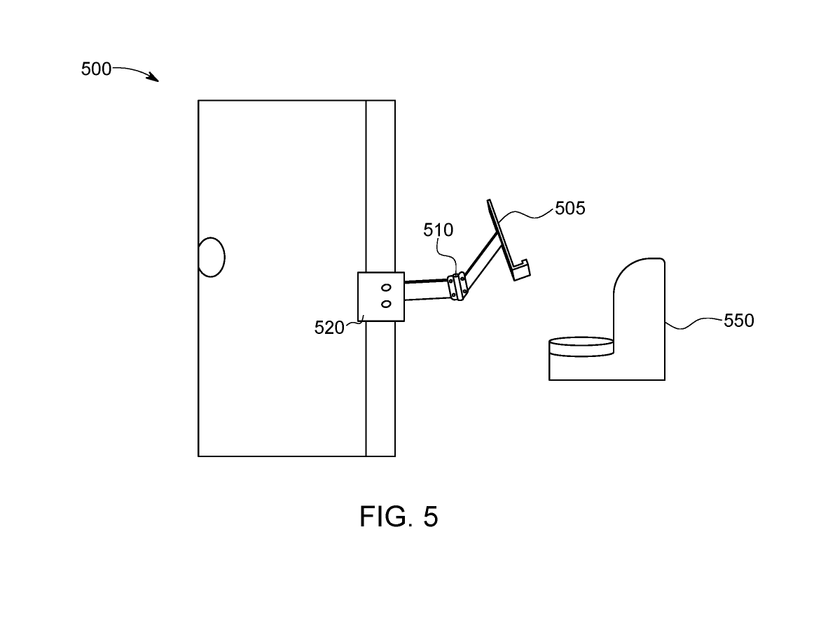

FIG. 5 depicts a simplified embodiment of the holding device 500. In this embodiment, the support cradle 505 can be mounted by a short non-flexible support arm 510 directly to a mount bracket 520. A CV joint can be interposed at a connection to either the support arm 510 or support cradle allowing for adjustment for viewing an electronic device for a user sitting on toilet 550.

In other alternative embodiments, the two-sided panel 120 can be modified for use in mounting to a bed frame or slid between box springs and a mattress.

In regards to the materials utilized in the present invention, the two-sided panel 120/200 and bracket 520 can be composed of high density metallic materials being significantly resistant under torsion and tension. Similarly, the support arm 311, 312, and 510 and the support cradle 105, 205, 305, 405, and 505 can also be comprised of high density rigid metallic materials. Support arms 110, 410, and 510 can include flexible metal members connected together. If a suction cup 424 is utilized, it may be composed of low density polymeric materials significantly pliable under torsion and tension to facilitate an airtight seal. In alternate embodiments of the present invention, it is easily conceivable for each component to be made of a particular material specifically suited to withstand the structural loads and thermal conditions associated with normal and extraneous operating conditions. Additionally, it is easily conceivable to those having ordinary skills in the relevant arts, that polymers, fabrics, metals, glass, organic, and/or composite materials may also be utilized.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An electronic device holding apparatus, comprising:
a support cradle for receiving and positioning an electronic device for use and viewing, the support cradle including a support base extending horizontally from the support cradle and a lip extending vertically upward from the support base, and wherein the support cradle includes a non-skid surface to aid keeping the electronic device in place;
a flexible support arm having a first end and a second end, the first end attached to the support cradle and the second end attached to a mounting plate;
wherein the mounting plate includes an attachment mechanism for attaching to a two-sided panel, the two-sided panel comprising a first side for mounting to an object and a second side for attaching to the mounting plate;
wherein the attachment mechanism for the second side comprises a male-female connection formed by a plurality of female slotted holes and a plurality of matching male protrusions.

2. The electronic device holding apparatus of claim 1, wherein the object comprises at least one of a door and a bed.

3. The electronic device holding apparatus of claim 2, wherein the object comprises a hinge and the first side includes holes aligned concentrically to match screws in a hinge of a door frame.

4. The electronic device holding apparatus of claim 1, wherein the non-skid surface includes a tacky surface.

5. The electronic device holding apparatus of claim 1, wherein the support arm includes at least one interposed joint between the mounting plate and the support cradle.

6. The electronic device holding apparatus of claim 5, wherein the joint comprises at least one of the following: CV joint, hinged joint, prismatic joint, cylindrical joint, planar joint, ball joint, and screw joint.

7. The electronic device holding apparatus of claim 5, wherein the two-sided panel comprises a hinge interposed therebetween.

8. A holding apparatus for hands-free use of an electronic device, comprising:
a support cradle for receiving and positioning an electronic device for use and viewing;
a support arm having a first end and a second end, the first end attached to the support cradle and the second end attached to a mounting plate, with at least one joint interposed between the support cradle and the mounting plate;
wherein the mounting plate includes an attachment mechanism for attaching to a two-sided panel, the two-sided panel comprising a first side for mounting to an object and a second side for attaching to the mounting plate.

9. The holding apparatus of claim 8, wherein the support arm is flexible and can be arranged into multiple shapes.

10. The holding apparatus of claim 8, wherein the attachment mechanism for the second side comprises a male-female connection formed by a plurality of female slotted holes and a plurality of matching male protrusions.
